(19) United States
(12) Patent Application Publication
(10) Pub. No.: US 2012/0219804 A1
(43) Pub. Date: Aug. 30, 2012

(54) LAYERED BODY

(76) Inventors: Kazuho Uchida, Osaka (JP); Tsutomu Ando, Osaka (JP); Daisuke Nakajima, Osaka (JP); Jiong Liu, Somerset, NJ (US); Ken Eberts, Somerset, NJ (US)

(21) Appl. No.: 13/037,119

(22) Filed: Feb. 28, 2011

(51) Int. Cl. B32B 27/38; C08J 7/04

(52) U.S. Cl. 428/413; 427/515

(57) ABSTRACT

A layered body (1) is provided in which a first layer (3) is deposited at one side on at least one surface of a resin substrate (2), a second layer (4) is deposited on the other side of the first layer (3) opposite to the one side thereof at which the first layer (3) is deposited on the resin substrate (2), the first layer (3) is a first organic-inorganic hybrid layer containing a (meth)acrylic resin and a silane compound, and the second layer (4) is a second organic-inorganic hybrid layer obtained by curing a composition made of a solution obtained by hydrolysis and condensation using a composition which contains a silane compound (A) containing at least one epoxy group and represented by the following Formula (1), an aluminum alkoxide (B) represented by the following Formula (2) and a tetrafunctional silane compound (C) represented by the following Formula (3):

Si(R1)ₚ(OR2)₄₋ₚ Formula (1);

Al(OR3)₃ Formula (2); and

Si(OR4)₄ Formula (3).

### TECHNICAL FIELD

This invention relates to a layered body in which a surface layer is deposited on a substrate made of resin, and more particularly relates to a layered body having a surface layer excellent in abrasion resistance.

### BACKGROUND ART

Poly(meth)acrylate resins and polycarbonate resins have excellent molding processability. Resin molded products made of poly(meth)acrylate resins or polycarbonate resins are lighter than glass. Therefore, these resin molded products are widely used for various applications including glasses, contact lens, and lens for optical devices. In particular, resin molded products made of polycarbonate resins have excellent impact resistance and are therefore suitably used as large-size resin molded products. For example, resin molded products made of polycarbonate resins are in practical use as head lamp lens for vehicles, hoods for motorbikes, and window materials for vehicles, trains, bullet trains and the like.

These resin molded products, however, have lower surface hardness than glass. Therefore, these resin molded products tend to become scratched during transportation or attachment of components or in use. In addition, the durability of these resin molded products is low.

Consequently, there is a need to enhance the surface hardness of these resin molded products. Heretofore, in order to enhance the hardness, a surface layer having high hardness is formed on the surface of such a resin molded product.

Patent Literature 1 discloses, as an example of materials for forming the surface layer, a surface layer-forming composition containing a polyfunctional acrylate monomer, colloidal silica, an acryloxy functional silane and a photopolymerization initiator. In Examples of Patent Literature 1,3-methacryloxypropyltrimethoxysilane is used as the acryloxy functional silane.

Patent Literature 2 discloses a surface layer-forming composition containing an ultraviolet-curable resin and a siloxane compound serving as a surface modifier. Patent Literature 2 specifically teaches, as examples of the ultraviolet-curable resin, acrylic oligomers containing at least two acryloyl groups in the molecule, and acrylic monomers or oligomers with colloidal silica linked thereto, and specifically teaches, as examples of the siloxane compound, polyether-modified dimethylpolysiloxane copolymers, polyether-modified methylalkylpolysiloxane copolymers, and polyester-modified dimethylpolysiloxane.

Patent Literature 3 discloses a surface-coated resin molded product produced by forming a primer layer on the surface of a resin molded product and then forming a top coat layer on the surface of the primer layer. The material for forming the primer layer used is a thermoplastic acrylic polymer. The material for forming the top coat layer used is a colloidal silica-filled organopolysiloxane.

### CITATION LIST

### Patent Literature

Patent Literature 1: JP-A-S57-131214
Patent Literature 2: JP-A-2003-338089
Patent Literature 3: JP-B-H04-002614

### SUMMARY OF INVENTION

### Technical Problem

When the surface layer-forming composition of Patent Literature 1 or 2 is used to form a surface layer on the surface of the resin molded product, the resulting surface layer may not have sufficient hardness.

In Patent Literature 3, in order to enhance the hardness of the surface, the top coat layer is formed after formation of the primer layer. Therefore, the production efficiency of the resin molded product coated with the surface layer is low. In addition, even when the material for forming the primer layer and the material for forming the top coat layer are used to form a surface layer, the resulting surface layer may not have sufficient hardness. Furthermore, the material for forming the top coat layer problematically requires a long curing time.

An object of the present invention is to provide a layered body having a surface layer of excellent abrasion resistance and a method for manufacturing the same.

### Solution to Problem

A wider aspect of the present invention provides a layered body including: a resin substrate; a first layer deposited at one side on at least one surface of the resin substrate; and a second layer deposited on the other side of the first layer opposite to the one side thereof at which the first layer is deposited on the resin substrate, wherein the first layer is a first organic-inorganic hybrid layer containing a (meth)acrylic resin and a silane compound, and the second layer is a second organic-inorganic hybrid layer obtained by curing a solution obtained by hydrolysis and condensation using a composition which contains a silane compound containing at least one epoxy group and represented by the following Formula (1), an aluminum alkoxide represented by the following Formula (2) and a tetrafunctional silane compound represented by the following Formula (3):

Si(R1)ₚ(OR2)₄₋ₚ Formula (1)

where R1 represents a C₁₋₃₀ organic group containing an epoxy group, R2 represents a C₁₋₆ alkyl group, p is 1 or 2, the R1s may be of the same or different types when p is 2, and the R2s may be of the same or different types;

Al(OR3)₃ Formula (2)

where R3 represents a C₁₋₆ alkyl group and the R3s may be of the same or different types; and

Si(OR4)₄ Formula (3)

where R4 represents a C₁₋₆ alkyl group and the R4s may be of the same or different types.

In a specific aspect of the layered body according to the present invention, the first layer is made of a cured product obtained by curing an active energy ray-curable composition containing: an inorganic polymer component obtained by hydrolyzing and condensing at least a silane compound represented by the following Formula (4); a water-soluble polyfunctional (meth)acrylate; and an active energy ray polymerization initiator:

Si(R5)ₚ(OR6)₄₋ₚ Formula (4)

where R5 represents a C₁₋₃₀ organic group containing a polymerizable double bond, R6 represents a C₁₋₆ alkyl group, p is 1 or 2, the R5s may be of the same or different types when p is 2, and the R6s may be of the same or different types.

In another specific aspect of the present invention, the water-soluble polyfunctional (meth)acrylate is an oxyalkylene-modified glycerol (meth)acrylate represented by the following Formula (5) or an alkylene glycol di(meth)acrylate represented by the following Formula (6):

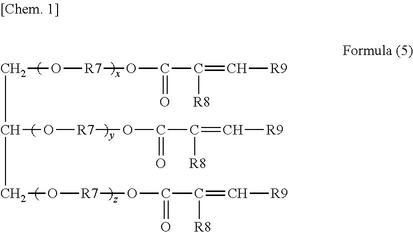

where R7 represents an ethylene group or a propylene group, R8 represents a hydrogen atom or a methyl group, R9 represents a hydrogen atom or a methyl group, the sum of x, y and z is an integer of 6 to 30, and the members of each of the set of R7s, the set of R8s and the set of R9s may be of the same or different types; or

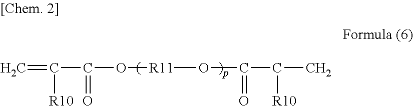

where R10 represents a hydrogen atom or a methyl group, R11 represents an ethylene group or a propylene group, and p is an integer of 1 to 25.

In still another specific aspect of the present invention, the layered body is obtained by coating the composition for forming the first layer on the resin substrate, then curing the composition by radical-co-polymerizing the water-soluble polyfunctional (meth)acrylate and polymerizable double bond moieties of the silane compound represented by the above Formula (5) by exposure to active energy rays, then coating the composition for forming the second layer on the cured composition and then curing the composition for forming the second layer by hydrolyzing and condensation-polymerizing alkoxy groups of metal alkoxides contained in the first and second layers by heat application.

In still another specific aspect of the present invention, the second layer is an organic-inorganic hybrid layer obtained by curing a solution containing not only the solution obtained by hydrolysis and condensation using the silane compound but also a silicone surfactant.

In still another specific aspect of the present invention, the first layer further contains at least one of an ultraviolet ray absorber and a hindered amine light stabilizer. More preferably, a hydroxyphenyltriazine ultraviolet ray absorber is used as the ultraviolet ray absorber.

A method for manufacturing a layered body according to the present invention includes: the step of coating a first composition containing a (meth)acrylic resin and a silane compound on at least one surface of a resin substrate; a curing step of curing the first composition by exposure to active energy rays to form a first layer; the step of coating on the first layer a second composition which contains a silane compound containing at least one epoxy group and represented by the above Formula (1), an aluminum alkoxide represented by the above Formula (2) and a tetrafunctional silane compound represented by the above Formula (3); and the step of curing the second composition by hydrolyzing and condensation-polymerizing alkoxy groups contained in the second composition by heat application to form a second layer. Preferably, the first layer is an organic-inorganic hybrid layer containing an inorganic polymer component containing an alkoxy group and a silanol group, and the method further includes the step of further curing the first layer by hydrolyzing and condensation-polymerizing the alkoxy group and the silanol group of the inorganic polymer component contained in the first layer simultaneously with the formation of the second layer. In this case, during the curing by heat application, the alkoxy and silanol groups of the metal alkoxide remaining in the first layer after being cured by exposure to active energy rays and the alkoxy and silanol groups of the metal alkoxide in the second layer are condensation copolymerized at the interface between the first and second layers. Thus, the adhesiveness between the first and second layers can be effectively increased. The more preferred composition for forming the first layer that can be used is a composition containing the silane compound represented by the above Formula (4), the water-soluble polyfunctional (meth)acrylate described above, and an active energy ray polymerization initiator.

### Advantageous Effects of Invention

In the layered body according to the present invention, the first layer formed of the first organic-inorganic hybrid layer and the second organic-inorganic hybrid layer formed by curing the above specific composition are deposited on the surface of the resin substrate. Therefore, the first and second layers can effectively enhance the abrasion resistance of the layered body surface. In addition, the weatherability can also be enhanced, providing a layered body less likely to be deteriorated in transparency even if it is exposed to sunlight and the like.

The manufacturing method of the present invention can provide a layered body having excellent surface abrasion resistance and excellent weatherability as described above.

### BRIEF DESCRIPTION OF DRAWINGS

FIG. 1(a) is a perspective view showing a layered body according to an embodiment of the present invention, and FIG. 1(b) is a front cross-sectional view showing the layered body.

FIGS. 2(a) to 2(c) are front cross-sectional views for illustrating a method for manufacturing the layered body according to the above embodiment of the present invention.

### DESCRIPTION OF EMBODIMENTS

Hereinafter, the present invention will be described in detail.

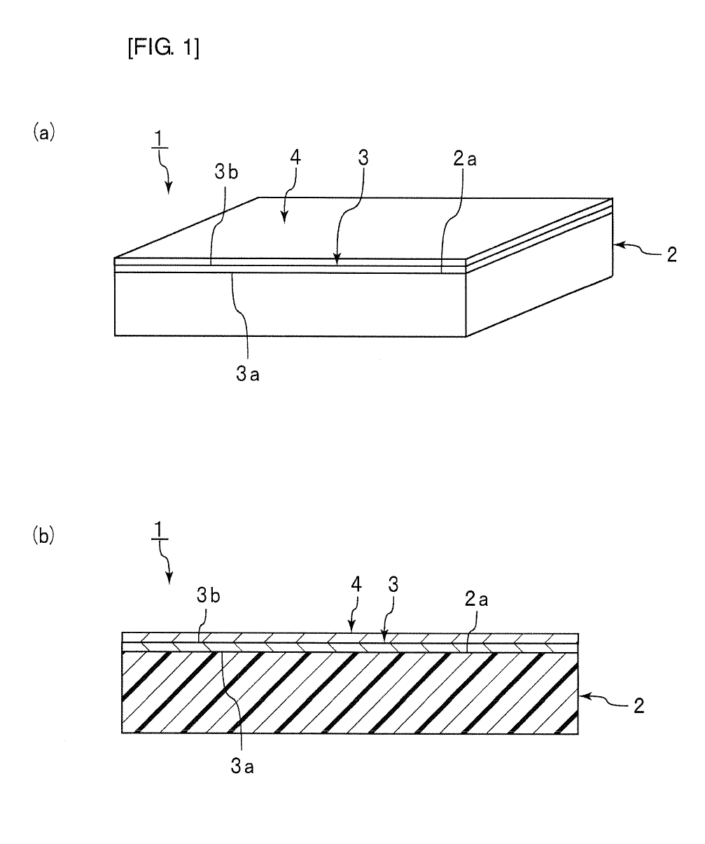

FIGS. 1(a) and 1(b) show a layered body according to an embodiment of the present invention in perspective and front cross-sectional views, respectively.

As shown in FIGS. 1(a) and 1(b), the layered body 1 includes a resin substrate 2, a first layer 3 deposited at one side 3a on a surface 2a of the resin substrate 2, and a second layer 4 deposited on the other side 3b of the first layer 3 opposite to the one side 3a thereof at which the first layer 3 is deposited on the resin substrate 2. The first and second layers 3 and 4 serve as a surface layer of the layered body 1.

The first layer 3 is deposited on the whole area of one of the two principal surfaces of the resin substrate 2. However, the first layer 3 may be deposited on at least a partial surface area of the resin substrate 2 and may not necessarily be deposited on the whole surface area of the resin substrate 2. For example, the first and second layers 3 and 4 may be deposited as a surface layer only on an area of the surface 2a of the resin substrate 2 required to have abrasion resistance. Furthermore, each of the two principal surfaces of the resin substrate 2 may have first and second layers 3 and 4 deposited as a surface layer thereon.

The resin substrate 2 is formed using a resin. No particular limitation is placed on the type of resin for forming the resin substrate 2. Examples of the resin for forming the resin substrate 2 include poly(meth)acrylate resins, polycarbonate resins, styrene resins, such as polyethylene terephthalate, polybutylene terephthalate and ABS, vinyl chloride resins, and cellulose acetate. Preferred among these resins are poly(meth)acrylate resins and polycarbonate resins, and more preferred among the above resins are polycarbonate resins. Poly(meth)acrylate resins and polycarbonate resins have excellent molding processability. Furthermore, resin substrates made of poly(meth)acrylate resins or polycarbonate resins are lighter than glass. In particular, resin substrates made of polycarbonate resins have excellent impact resistance. Therefore, the resin substrate 2 is preferably a poly(meth)acrylate resin substrate or a polycarbonate resin substrate and is more preferably a polycarbonate resin substrate.

No particular limitation is placed on the shape of the resin substrate 2. For example, a plate-like shape or a film-like shape can be selected as the shape of the resin substrate 2.

The first layer 3 is provided in order to enhance the adhesiveness of the resin substrate 2 to the second layer 4. Therefore, the thickness of the first layer 3 can be appropriately selected to enhance the adhesiveness. The preferred minimum thickness of the first layer 3 is 1 μm, and the preferred maximum thickness thereof is 20 μm. From the viewpoint of sufficiently enhancing the abrasion resistance, the preferred minimum thickness of the second layer 4 is 0.1 μm and the preferred maximum thickness thereof is 20 μm.

Next, a description will be given of the surface layer consisting of the first and second layers which is a feature of the present invention.

(First Layer)

The first layer in the present invention is a first organic-inorganic hybrid layer containing a (meth)acrylic resin and a silane compound. No particular limitation is placed on the material constituting the first layer, provided that it is an organic-inorganic hybrid material containing a (meth)acrylic resin and a silane compound.

Most preferably, the first layer is made of a cured product obtained by curing a first composition containing an inorganic polymer component obtained by hydrolyzing and condensing at least a silane compound represented by Formula (4), a water-soluble polyfunctional (meth)acrylate, and an active energy ray polymerization initiator. In other words, the first composition is an active energy ray-curable composition.

The term “inorganic polymer component” used herein means a component which is used for production of an inorganic polymer and constitutes at least part of the backbone of the produced inorganic polymer.

The inorganic polymer is an inorganic polymer obtained by hydrolyzing and condensing an inorganic polymer component or components, including a silane compound represented by the following Formula (4):

Si(R5)ₚ(OR6)₄₋ₚ Formula (4).

In Formula (4), R5 represents a C₁₋₃₀ organic group containing a polymerizable double bond, R6 represents a C₁₋₆ alkyl group, and p is 1 or 2. When p is 2, the R5s may be of the same or different types. The R6s may be of the same or different types.

An example of the polymerizable double bond in R5 in Formula (4) is a carbon-carbon double bond.

Specific examples of R5 in Formula (4) include vinyl group, allyl group, isopropenyl group, and 3-(meth)acryloxyalkyl groups. The term “(meth)acryloxy” used herein means methacryloxy or acryloxy.

Examples of the (meth)acryloxyalkyl groups include (meth)acryloxymethyl group, (meth)acryloxyethyl group, and (meth)acryloxypropyl group. Particularly preferably, R1 is a (meth)acryloxyalkyl group. The minimum number of carbon atoms in R1 is preferably 2, and the maximum number of carbon atoms in R5 is preferably 30 and more preferably 10.

Specific examples of R6 in Formula (4) include methyl group, ethyl group, n-propyl group, isopropyl group, n-butyl group, and isobutyl group.

Specific examples of the silane compound represented by the above Formula (4) include 3-(meth)acryloxypropyltrimethoxysilane (MPTS), 3-(meth)acryloxypropyltriethoxysilane, and 3-(meth)acryloxypropylmethyldimethoxysilane. Any one of these silane compounds represented by the above Formula (1) may be used alone or any combination of two or more thereof may be used.

The inorganic polymer may further contain one or more additional inorganic polymer components which are compounds different from the compound represented by Formula (4). Examples of such additional compounds include tetrafunctional silane compounds, such as tetramethoxysilane (TMOS) and tetraethoxysilane (TEOS), trifunctional silane compounds, such as methyltrimethoxysilane (MeTS), ethyltrimethoxysilane, n-propyltrimethoxysilane, isobutyltrimethoxysilane, n-hexyltrimethoxysilane, phenyltrimethoxysilane, n-octyltrimethoxysilane, n-decyltrimethoxysilane, methyltriethoxysilane, ethyltriethoxysilane, n-propyltriethoxysilane, isobutyltriethoxysilane, n-hexyltriethoxysilane, n-octyltriethoxysilane, n-decyltriethoxysilane and phenyltriethoxysilane, and bifunctional silane compounds, such as dimethyldimethoxysilane, diethyldimethoxysilane, diisopropyldimethoxysilane, diisobutyldimethyldimethoxysilane, diphenyldimethoxysinane, dimethyldiethoxysilane, diethyldiethoxysinale, diisopropyldiethoxysilane, diisobutyldimethyldiethoxysilane and diphenyldiethoxysilane. The additional compound or compounds may be copolymerized or graft-polymerized with the compound represented by the above Formula (4), unless they deteriorate the transparencies and abrasion resistances of the first layer 3 and the surface layer including the first layer 3.

The inorganic polymer can be obtained by adding either one of a solvent and water, a catalyst and the like to the inorganic polymer component or components including the compound represented by the above Formula (4), hydrolyzing and condensing the inorganic polymer components by a sol-gel method to obtain a reaction solution, and removing, from the reaction solution, the solvent, water, and alcohols and the like produced by the condensation.

No particular limitation is placed on the solvent used, provided that it can dissolve the compound represented by the above Formula (4). Specific examples of the solvent include alcoholic solvents, such as methanol, ethanol, n-propanol and isopropanol, ether solvents, such as tetrahydrofuran, 1,4-dioxane, 1,3-dioxane and diethylether, hydrocarbon solvents, such as benzene, toluene and n-hexane, ketone solvents, such as acetone, methyl ethyl ketone and cyclohexanone, and ester solvents, such as ethyl acetate and butyl acetate. Any one of these solvents may be used alone or any combination of two or more thereof may be used. Preferred among these solvents are low-boiling-point solvents because of their ease of volatilization. Preferred examples of the low-boiling-point solvents that may be used include alcoholic solvents, such as methanol, ethanol, n-propanol and isopropanol.

Water for use in the hydrolysis reaction may be added to convert the alkoxy groups of the compound represented by the above Formula (4) into hydroxyl groups. The amount of water used in the hydrolysis reaction is preferably added to give 0.1 to 10 molar equivalents per mole of the alkoxy groups. If the amount of water used in the hydrolysis reaction is too small, the hydrolysis reaction and the condensation reaction do not sufficiently proceed, whereby the inorganic polymer may not be produced. If the amount of water used in the hydrolysis reaction is too large, the inorganic polymer may turn into a gel. Therefore, the reaction time and temperature should be controlled to the optimal time and temperature.

Specific examples of the catalyst include inorganic acids, such as hydrochloric acid, sulfuric acid, nitric acid, phosphoric acid, nitrous acid, perchloric acid and sulfamic acid, and organic acids, such as formic acid, acetic acid, propionic acid, butyric acid, oxalic acid, succinic acid, maleic acid, lactic acid, p-toluenesulfonic acid and acrylic acid. Preferred among these catalysts are hydrochloric acid, acetic acid and acrylic acid because of ease of control of the hydrolysis reaction and condensation reaction.

No particular limitation is placed on the type of water-soluble polyfunctional (meth)acrylate contained in the active energy ray-curable composition, provided that it is water-soluble and has two or more (meth)acryloyl groups. Only one type of water-soluble polyfunctional (meth)acrylate may be used alone or any combination of two or more types of water-soluble polyfunctional (meth)acrylates may be used. The term “(meth)acryloyl” used herein means acryloyl or methacryloyl. The term “(meth)acrylate” means acrylate or methacrylate.

Specific examples of the water-soluble polyfunctional (meth)acrylate include triethylene glycol di(meth)acrylate and pentaerythritol tri(meth)acrylate.

Further examples of the water-soluble polyfunctional (meth)acrylate include oxyalkylene-modified glycerol (meth)acrylates represented by the following Formula (2) and alkylene glycol di(meth)acrylates represented by the following Formula (3). Preferred among the above water-soluble polyfunctional (meth)acrylates are oxyalkylene-modified glycerol (meth)acrylates represented by the following Formula (5) and alkylene glycol di(meth)acrylates represented by the following Formula (6). The use of these preferred water-soluble polyfunctional (meth)acrylates further enhances the abrasion resistances of the first layer 3 and the surface layer including the first layer 3.

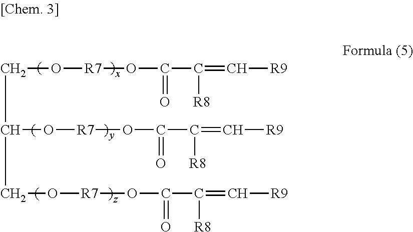

In Formula (5), R7 represents an ethylene group or a propylene group, R8 represents a hydrogen atom or a methyl group, R9 represents a hydrogen atom or a methyl group, and the sum of x, y and z is an integer of 6 to 30. The members of each of the set of R7s, the set of R8s and the set of R9s may be of the same or different types.

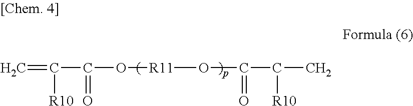

In Formula (6), R10 represents a hydrogen atom or a methyl group, R11 represents an ethylene group or a propylene group, and p is an integer of 1 to 25.

The water-soluble polyfunctional (meth)acrylate preferably contains at least three alkylene glycol units, more preferably contains at least six alkylene glycol units, and still more preferably contains at least nine alkylene glycol units. A larger number of alkylene glycol units provide higher abrasion resistances of the first layer 3 and the surface layer including the first layer 3.

No particular limitation is placed on the weight ratio between the inorganic polymer and the water-soluble polyfunctional (meth)acrylate in the active energy ray-curable composition. However, if the content of the water-soluble polyfunctional (meth)acrylate is too large, the adhesiveness between the first and second layers 3 and 4 is lowered and the abrasion resistance tends to be low. Therefore, the weight ratio between the inorganic polymer and the water-soluble polyfunctional (meth)acrylate (inorganic polymer:water-soluble polyfunctional (meth)acrylate) in the active energy ray-curable composition is preferably 5:95 to 90:10 and more preferably 10:90 to 60:40.

The water-soluble polyfunctional (meth)acrylate may be added after the polymerization of the inorganic polymer components through the hydrolysis and condensation reactions by a sol-gel method and the subsequent removal of the solvent, water and the like. Alternatively, the water-soluble polyfunctional (meth)acrylate may be added immediately after the polymerization of the inorganic polymer components and before the removal of the solvent, water and the like.

No particular limitation is placed on the type of active energy ray polymerization initiator contained in the active energy ray-curable composition, but preferred is a photopolymerization initiator that produces radicals in response to exposure to active energy rays. Among usable photopolymerization initiators are commercially available photopolymerization initiators.

Examples of the photopolymerization initiator include benzoin compounds, acetophenone compounds, anthraquinone compounds, thioxanthone compounds, ketal compounds, benzophenone compounds, and phosphine oxide compounds. Any one of these photopolymerization initiators may be used alone or any combination of two or more thereof may be used.

Examples of the benzoin compounds include benzoin, benzoin methyl ether, benzoin ethyl ether, benzoin propyl ether, and benzoin isobutyl ether.

Examples of the acetophenone compounds include acetophenone, 2,2-diethoxy-2-phenylacetophenone, 2,2-dimethoxy-1,2-diphenylethane-1-one, 1,1-dichloroacetophenone, 2-hydroxy-2-methyl-phenylpropane-1-one, diethoxyacetophenone, 1-hydroxycyclohexyl phenyl ketone, and 2-methyl-1-[4-(methylthio)phenyl]-2-morpholinopropane-1-one.

Examples of the anthraquinone compounds include 2-ethylanthraquinone, 2-t-butylanthraquinone, 2-chloroanthraquinone, and 2-amylanthraquinone. Examples of the thioxanthone compounds include 2,4-diethylthioxanthone, 2-isopropylthioxanthone, and 2-chlorothioxanthone.

Examples of the ketal compounds include acetophenone dimethyl ketal and benzyl dimethyl ketal.

Examples of the benzophenone compounds include benzophenone, 4-benzoyl-4′-methyldiphenylsulfide, and 4,4′-bismethylaminobenzophenone.

Examples of the phosphine oxides include 2,4,6-trimethylbenzoyldiphenylphosphine oxide, bis-(2,6-dimethoxybenzoyl)-2,4,4-trimethylpentylphosphine oxide, and bis(2,4,6-trimethylbenzoyl)-phenylphosphine oxide.

In view of preventing yellowing after exposure to light, the preferred photopolymerization initiators are acetophenone compounds and phosphine oxide compounds. In view of further preventing yellowing after exposure to light, the preferred photopolymerization initiators are 2,2-dimethoxy-1,2-diphenylethane-1-one, 1-hydroxycyclohexyl phenyl ketone, 2-methyl-1-[4-(methylthio)phenyl]-2-morpholinopropane-1-one, 2,4,6-trimethylbenzoyldiphenylphosphine oxide, and bis-(2,6-dimethoxybenzoyl)-2,4,4-trimethylpentylphosphine oxide, and the more preferred photopolymerization initiators are 2,2-dimethoxy-1,2-diphenylethane-1-one and 1-hydroxycyclohexyl phenyl ketone.

The content of the active energy ray polymerization initiator can be appropriately controlled depending on the type and number of moles of polymerizable double bonds of the components in the active energy ray-curable composition, and the irradiation energy (dose) of active energy rays, such as ultraviolet rays. The content of the active energy ray polymerization initiator is preferably in the range of 0.5% to 20% by weight per 100% by weight in total of the inorganic polymer, the water-soluble polyfunctional (meth)acrylate and the active energy ray polymerization initiator. The preferred minimum content of the active energy ray polymerization initiator is 2% by weight, and the preferred maximum content thereof is 15% by weight. If the content of the active energy ray polymerization initiator is too small, the polymerization reaction may not sufficiently proceed, whereby the abrasion resistances of the first layer 3 and the surface layer including the first layer 3 tend to be low. If the content of the active energy ray polymerization initiator is too large, the first layer 3 and the surface layer including the first layer 3 may develop cracks or cause exudation of decomposed substances to the surface during exposure to active energy rays or owing to exposure to ultraviolet rays or the like of the layered body 1 in use. Thus, the external appearance of the layered body 1 may become poor.

The active energy ray-curable composition can be prepared by mixing the inorganic polymer, the water-soluble polyfunctional (meth)acrylate, the active energy ray polymerization initiator, and optionally other components.

(Second Layer)

The second layer is a second organic-inorganic hybrid layer obtained by curing a solution obtained by hydrolysis and condensation using a second composition for forming a second layer, wherein the second composition contains a silane compound (A) containing at least one epoxy group and represented by the following Formula (1), an aluminum alkoxide (B) represented by the following Formula (2), and a tetrafunctional silane compound (C) represented by the following Formula (3):

Si(R1)ₚ(OR2)₄₋ₚ Formula (1)

where R1 represents a C₁₋₃₀ organic group containing an epoxy group, R2 represents a C₁₋₆ alkyl group, and p is 1 or 2, the R1s may be of the same or different types when p is 2, and the R2s may be of the same or different types;

Al(OR3)₃ Formula (2)

where R3 represents a C₁₋₆ alkyl group and the R3s may be of the same or different types; and

Si(OR4)₄ Formula (3)

where R4 represents a C₁₋₆ alkyl group and the R4s may be of the same or different types.

No particular limitation is placed on the type of silane compound (A), provided that it is a silane compound that can be represented by Formula (1). Examples of such a silane compound (A) include 3-glycidoxypropyltrimethoxysilane (GPTS), 3-glycidoxypropyltriethoxysilane and 2-(3,4-epoxycyclohexyl)ethyltrimethoxysilane. The preferred silane compound (A) that may be used is 3-glycidoxypropyltrimethoxysilane (GPTS) or 3-glycidoxypropyltriethoxysilane because they can provide high abrasion resistance.

No particular limitation is also placed on the type of aluminum alkoxide (B), provided that it satisfies the above Formula (2). Examples of such an aluminum alkoxide (B) include aluminum sec-butoxide (ASB) and aluminum isopropoxide.

The tetrafunctional silane compound (C) represented by the above Formula (3) has hydrolizability and acts as a crosslinker. Examples of such a tetrafunctional silane compound (C) include tetramethoxysilane and tetraethoxysilane.

No particular limitation is placed on the compounding ratio among the silane compound (A) represented by Formula (1), the aluminum alkoxide represented by Formula (2) and the tetrafunctional silane compound (C) represented by Formula (3) in the second composition used to form the second layer. However, the content of the aluminum alkoxide (B) is preferably in the range of 0.11 to 0.53 mol per mole of the silane compound (A) represented by Formula (1). The reason why the content of the aluminum alkoxide (B) in this range is preferable is that epoxy groups of the silane compound (A) represented by Formula (1) can be effectively ring-opening polymerized to synthesize an ethyleneoxide oligomer, thereby providing high abrasion resistance.

The content of the tetrafunctional silane compound (C) acting as a crosslinker is preferably in the range of 0.26 to 1.5 mol per mole of the silane compound (A) represented by the above Formula (1). If the content of the tetrafunctional silane compound (C) is in this range, the hydrolysis and condensation can be more effectively promoted, whereby the abrasion resistance can be further enhanced.

In the present invention, the second composition constituting the second layer preferably further contains an acid (D). No particular limitation is placed on the type of acid (D) used. Examples of the acid (D) include nitric acid, hydrochloric acid and acetic acid.

Although no particular limitation is placed on the content of the acid (D) and the acid (D) can be added in an appropriate ratio depending on the type thereof, the acid (D) is preferably added to provide a pH of the composition in the range of 1 to 3 and provide a molar ratio of acid (D):crosslinker (C) of 0.02:1 to 0.08:1. If the content of the acid (D) is in these ranges, the storage stability of the composition can be increased.

The second composition for forming the second layer preferably further contains at least one type of surfactant (E) in the form of a nonreactive silicone compound. Although no particular limitation is placed on such a surfactant (E) usable, an example of the surfactant (E) is a surfactant “BYK 346” manufactured by BYK-Chemie. The content of the surfactant in the composition forming the second layer is preferably 0.1% to 1.0% by weight and more preferably 0.1% to 0.5% by weight. If the content of the surfactant (E) is in the above preferred range, the surface smoothness of the second layer can be increased, whereby the transparency and external appearance quality can be increased.

Furthermore, in order to promote hydrolysis, an appropriate amount of water is preferably added to the second composition for forming the second layer.

The second layer can be formed by hydrolyzing and condensing the composition for forming the second layer to form a solution and curing the solution.

The details of the steps of forming the first layer and forming the second layer will be described later.

(Manufacturing of Layered body)

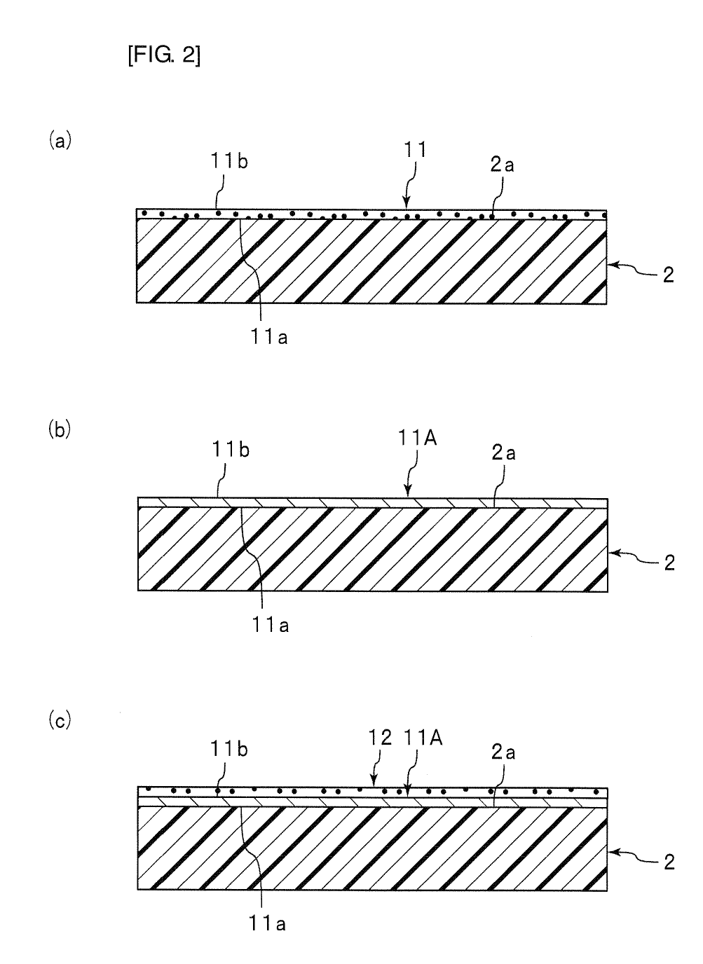

Next, a description will be given of an embodiment of a method for manufacturing a layered body according to the present invention with reference to FIGS. 2(a) to 2(c).

As shown in FIG. 2(a), a first composition is coated on a surface 2a of a resin substrate 2 to form a first composition layer 11.

Thereafter, as shown in FIG. 2(b), the first composition layer 11 is irradiated with active energy rays to cure the first composition layer 11. When the first composition layer 11 is exposed to the active energy rays, a photocured first composition layer 11A is formed.

Specifically, when the first composition layer 11 is exposed to active energy rays, an active energy ray polymerization initiator, for example, is decomposed to produce radicals, so that a first polymerization reaction occurs between the water-soluble polyfunctional (meth)acrylate and the polymerizable double bond of the inorganic polymer derived from the silane compound represented by the above Formula (1) and crosslinking also proceeds.

Examples of such active energy rays to be used in curing the first composition layer 11 include ultraviolet rays, electron beams, α-rays, β-rays, γ-rays, X-rays, infrared rays and visible light rays. Preferred among these types of active energy rays are ultraviolet rays and electron beams because they provide excellent curability and resulting cured products are less likely to degrade.

To cure the first composition layer 11 by exposure to ultraviolet rays, various ultraviolet irradiation devices can be used. Examples of usable light sources include xenon lamps, high-pressure mercury lamps, and metal halide lamps. The ultraviolet irradiation energy (dose) is preferably in the range of 10 to 10,000 mJ/cm² and more preferably in the range of 100 to 5,000 mJ/cm². If the ultraviolet irradiation energy is too low, the first composition layer 11 is less likely to be cured, whereby the first layer 3 and the surface layer including the first layer 3 tend to have low abrasion resistance or the first layer 3 tends to have poor adhesiveness. If the ultraviolet irradiation energy is too high, the first layer 3 and the surface layer including the first layer 3 may be degraded or may be less transparent.

To cure the first composition layer 11 by exposure to electron beams, various electron beam irradiation devices can be used. The electron beam irradiation energy (dose) is preferably in the range of 0.5 to 20 Mrad and more preferably in the range of 1.0 to 10 Mrad. If the electron beam irradiation energy is too low, the first composition layer 11 is less likely to be cured, whereby the first layer 3 and the surface layer including the first layer 3 tend to have low abrasion resistance. If the electron beam irradiation energy is too high, the first layer 3 and the surface layer including the first layer 3 may be degraded or may be less transparent.

Next, as shown in FIG. 2(c), a second composition is coated on the photocured first composition layer 11A, which has been deposited at one side 11a on the resin substrate 2, so that the second composition is applied to the other side 11b of the first composition layer 11A opposite to the one side 11a thereof. Thus, a second composition layer 12 is formed.

The cured conditions of the photocured first composition layer 11A at the beginning of formation of the second composition layer 12 only have to be such that the photocured first composition layer 11A has been cured to an extent that the interface between the photocured first composition layer 11A and the second composition layer 12 is not disturbed by the formation of the second composition layer 12. If the crosslinking of the photocured first composition layer 11A has proceeded sufficiently, the surface layer of the resulting layered body can have high abrasion resistance.

Next, the photocured first composition layer 11A and the second composition layer 12 are heated, whereby the first composition layer 11A is further cured and the second composition layer 12 is cured. More specifically, through the firing using the above heat application, the photocrosslinked inorganic polymer contained in the already photocured first composition layer 11A is further condensed and thus a second condensation reaction proceeds. Thereby, the already photocured first composition layer 11A is further cured. As a result, a first layer 3 having very high hardness can be formed. Simultaneously, through the above heat application, the second composition layer 12 is cured to form a very hard second layer 4.

In addition, during the firing, the photocrosslinked inorganic polymer contained in the already photocured first composition layer 11A is also condensed with alkoxy groups and silanol groups contained in the second composition layer 12. Therefore, the adhesiveness between the first layer 3 and the second layer 4 can be effectively increased. Thus, the abrasion resistance of the surface layer composed of the first and second layers 3 and 4 can be further enhanced.

The temperature at which the already photocured first composition layer 11A and the second composition layer 12 are cured by heat application is not particularly limited and can be determined considering the thermal resistance of the resin substrate. The preferred temperature is in the range of 50° C. to 200° C. The heating time, i.e., curing time, is preferably in the range of 0.4 hours to 4 hours.

Although no particular limitation is placed on the thickness of the second layer cured in the above manner, the preferred thickness is 1 μm to 20 μm and the more preferred thickness is 2 μm to 10 μm. So long as the thickness is in the above preferred range, a second layer having extremely excellent abrasion resistance can be easily formed.

Furthermore, to provide excellent abrasion resistance, the thickness ratio between the first and second layers is not particularly limited and can be selected based on the required quality.

The following describes a specific example of the method for forming a second layer.

The silane compound (A) and the aluminum alkoxide (B) are mixed. Preferably, the aluminum alkoxide is diluted with an alcohol into a solution having a concentration of 70% to 90% by weight.

Next, water is added to the mixture. The amount of water added can be selected so that the solution to be fired has a solid concentration of 10% to 40% by weight. Next, the mixture is stirred at a temperature of 50° C. to 80° C. to form a slurry. While being stirred, the slurry gradually turns translucent and becomes a transparent sol in 0.5 to 2 hours.

Next, to control the pH to within the range of 1 to 3, the acid (D) is added to the sol. The tetrafunctional silane compound (C) serving as a crosslinker is further added to the sol, followed by stirring for 2 to 4 hours. Next, the surfactant (A) is added to the sol immediately before the coating on the first layer. In order to obtain a stable coating solution, the acid (D) is preferably added to the sol to catalyze the hydrolysis of the tetrafunctional silane compound (C) and maintain the pH of the sol in the above range. The molar ratio of the acid (D) to the tetrafunctional silane compound (C) acting as a crosslinker is preferably in the range of 0.02 to 0.08.

No particular limitation is placed on the coating process for the second composition for forming the second layer. Standard coating processes can be used, such as dipping, spin coating, brushing and spraying. After being coated at room temperature, the second composition for forming the second layer is cured. Preferably, the curing is implemented by heat application and the heating temperature is in the range of 50° C. to 200° C.

Next, the present invention is described in detail by way of Examples and Comparative Examples.

First compositions M1 to M5 for forming first layers and second compositions N1 to N6 for forming second layers were prepared as follows.

(First Composition M1)

An amount of 95.2 g of ethanol, 99.4 g (0.4 mol) of 3-methacryloxypropyltrimethoxysilane (MPTS) and 109.0 g (0.8 mol) of methyltrimethoxysilane (MeTS) were added to a flask and mixed into a mixture. While the obtained mixture was cooled to 0° C., dilute hydrochloric acid prepared by diluting 8.75 g of 12 N concentrated hydrochloric acid with 30.4 g of water was added dropwise to the mixture and stirred for 10 minutes. The mixture was further stirred at room temperature for 10 minutes to obtain a mixed solution. The obtained mixed solution was heated to 80° C. and concentrated by an evaporator to obtain 125.0 g of a viscous and transparent inorganic polymer-containing solution.

The following materials were then added to the obtained inorganic polymer-containing solution to prepare a first composition M1: 500.0 g of ethoxylated glycerol triacrylate (NK ester A-GLY-9E, manufactured by Shin-Nakamura Chemical Co., Ltd.) as a (meth)acrylate; 50 g of Tinuvin 400 (manufactured by Ciba Specialty Chemicals) as a hydroxyphenyltriazine ultraviolet ray absorber; 12.5 g of Tinuvin 292 as a hindered amine light stabilizer; 31.3 g of 2,2-dimethoxy-1,2-diphenylethane-1-one (Irgacure 651, manufactured by Ciba Specialty Chemicals) as a photopolymerization initiator; and 625.0 g of isopropyl alcohol.

(First Compositions M2 to M5)

First compositions M2 to M5 were prepared in the same manner as the first composition M1 except that the chemical constitution was changed as shown in Table 1 below.

(First Composition M6)

A first composition M6 was prepared by mixing materials to have a chemical constitution shown in Table 1 below.

TABLE 1

| | First Composition | | | | | |
|---|---|---|---|---|---|---|
| | M1 | M2 | M3 | M4 | M5 | M6 |
| MPTS | 99.4 | 99.4 | 99.4 | 198.7 | 99.4 | |
| MeTS | 109.0 | 109.0 | 109.0 | | 109.0 | |
| Inorganic Polymer | 125.0 | 125.0 | 125.0 | 120.0 | 125.0 | |
| A-GLY-9E | 500.0 | 500.0 | 250.0 | 480.0 | 500.0 | 500.0 |
| 4EG-A | | | 250.0 | | | |
| Tinuvin400 | 50.0 | | 50.0 | 48.0 | | 30.0 |
| Tinuvin109 | | 50.0 | | | | |
| Tinuvin292 | 12.5 | 12.5 | 12.5 | 12.0 | 12.5 | 7.5 |
| Irgacure651 | 31.3 | 31.3 | 31.3 | 30.0 | 31.3 | 18.8 |

The meanings of the abbreviations in Table 1 are as follows:

MPTS: 3-Methacryloxypropyltrimethoxysilane

MeTS: Methyltrimethoxysilane

A-GLY-9E: Ethoxylated glycerol triacrylate, manufactured by Shin-Nakamura Chemical Co., Ltd.

4EG-A: Tetraethylene glycol diacrylate

Tinuvin 400: Hydroxyphenyltriazine ultraviolet ray absorber (Ciba Specialty Chemicals)

Tinuvin 109: Hydroxyphenyltriazine ultraviolet ray absorber (Ciba Specialty Chemicals)

Tinuvin 292: Hydroxyphenyltriazine ultraviolet ray absorber (Ciba Specialty Chemicals)

Irgacure 651: 2,2-dimethoxy-1,2-diphenylethane-1-one, manufactured by Ciba Specialty Chemicals

(Second Composition N1)

An amount of 61.6 g (0.2 mol) of aluminum sec-butoxide (ASB) diluted to 80% with isopropyl alcohol and 206.92 g (11.5 mol) of water were added to 118.2 g (0.5 mol) of 3-glycidoxypropyltrimethoxysilane (GPTS) and stirred in a water bath at 70° C. for 30 minutes, and the mixture was cooled back to room temperature. An amount of 8.8 g of nitric acid diluted to 10% was added dropwise to the mixture, followed by addition of 41.7 g (0.2 mol) of tetraethoxysilane (TEOS). The mixture was further stirred at room temperature for 2 hours, and an amount of 0.38 g of silicone surfactant (BYK 346, manufactured by BYK Chemie) was then added to the mixture to prepare a second composition N1.

(Second Compositions N2 to N6)

Second compositions N2 to N6 were prepared in the same manner as the second composition N1 in accordance with the respective chemical constitutions shown in Table 2 below.

TABLE 2

| | Second Composition | | | | | | | |
|---|---|---|---|---|---|---|---|---|
| | N1 | N2 | N3 | N4 | N5 | N6 | N7 | N8 |
| GPTS | 118.2 | 118.2 | 118.2 | 118.2 | 118.2 | 118.2 | 118.2 | |
| Al-sec- | 61.6 | 30.8 | 30.8 | 49.3 | 61.6 | 49.3 | | 30.8 |
| butoxide | | | | | | | | |
| (80%) | | | | | | | | |
| TEOS | 41.7 | 72.9 | 62.5 | 41.7 | 41.7 | | 41.7 | 145.9 |
| HNO3 (10%) | 8.8 | 17.6 | 17.6 | 8.8 | 8.8 | | 8.8 | 8.8 |
| BYK346 | 0.7 | 0.7 | 0.7 | 0.7 | | | 0.7 | 0.7 |
| Solid | 105.9 | 109.8 | 106.8 | 103.9 | 105.9 | 91.9 | 95.7 | 250.0 |

The meanings of the abbreviations in Table 2 are as follows:

GPTS: 3-Glycidoxypropyltrimethoxysilane

Al-sec-Butoxide (80%): Aluminum sec-butoxide diluted to 80% with isopropyl alcohol

TEOS: Tetraethoxysilane

HNO₃ (10%): Nitric acid diluted to 10%

BYK 346: Silicone surfactant

Solid: Solid weight after cured

Various layered bodies of the following Examples 1 to 9 and Comparative Examples 1 to 4 were each produced by combining one of the first compositions M1 to M5 obtained in the above manner with one of the second compositions N1 to N6.

### Example 1

A commercially-available transparent colorless polycarbonate board (10 cm in length, 10 cm in width and 4 mm in thickness) was prepared. The first composition M1 shown in Table 1 was uniformly coated on this polycarbonate board with a spin coater to form a first composition layer. The first composition layer was dried at room temperature (25° C.) for 10 minutes. Then, the first composition layer was irradiated with ultraviolet rays from a 120 W high-pressure mercury lamp at a dose of 4000 mJ/cm² in a nitrogen atmosphere.

Next, the second composition N1 shown in Table 1 was uniformly coated on the photocured first composition layer with a spin coater to form a second composition layer. The second composition layer was dried at room temperature (25° C.) for 10 minutes. Subsequently, the second composition layer was heated in an oven at 125° C. for 2 hours. Thus, first and second layers were formed as a surface layer on the top side of the polycarbonate board, thereby producing a layered body.

### Examples 2 to 9

Individual layered bodies were produced in the same manner as in Example 1 except that the first and second compositions constituting the first and second layers were changed as shown in Table 3 below.

As for Example 7, however, after the irradiation with ultraviolet rays, the first composition was fired by heat application in an oven at 125° C. for 2 hours. The layered body of Example 7 was otherwise produced in the same manner as in Example 1.

### Comparative Examples 1 to 4

Individual layered bodies were produced in the same manner as in Example 1 except that the compositions of the first and second layers were changed as shown in Table 3 below.

### Evaluation of Examples and Comparative Examples

(1) Thicknesses of First and Second Layers

Thin sections were cut from each layered body with an ultramicrotome. The thicknesses of the first and second layers were evaluated by observing the cross sections of the obtained thin sections under a transmission electron microscope.

(2) External Appearance

The conditions of the surface layer after the firing were visually observed and evaluated based on the following evaluation criteria.

Evaluation Criteria

∘: The surface layer was colorless and uniform.

Δ: The surface layer had some uneven portions, and a see-through image was distorted or the coat was cloudy.

x: The surface layer had cracks.

(3) Evaluation of Transparency

The haze value of each polycarbonate board with a surface layer formed thereon was measured with a haze meter (“TC-HIIIDPK” manufactured by Tokyo Denshoku Co., Ltd.) in accordance with JIS K7136. A smaller haze value implies a higher transparency.

Measurement of the haze value of the polycarbonate board with no surface layer formed thereon resulted in 0.2%.

(4) Evaluation of Degree of Yellowing

The degree of yellowing ΔYI of each layered body was measured with a color analyzer (“TC-1800 MK-II” manufactured by Tokyo Denshoku Co., Ltd.) in accordance with JIS K7105.

(5) Evaluation of Abrasion Resistance

The abrasion resistance of each layered body was evaluated in accordance with JIS R3212, using a Taber abrasion tester “rotary abrasion tester TS” manufactured by Toyo Seiki Seisaku-sho, Ltd. and provided with a horizontal rotating table rotatable at a speed of 70 revs/min and a pair of smoothly rotatable abrasion wheels fixed at intervals of 65±3 mm. The abrasion wheels were CS-10F (Type IV). The haze difference (Δhaze %) between the haze after 500 cycles of the abrasion test under a load of 500 g and the initial haze was determined.

Measurement of the haze difference (Δhaze %) of the polycarbonate board with no surface layer formed thereon resulted in 48%. The surface layer of the layered body of Comparative Example 2 had cracks and was therefore not evaluated for abrasion resistance.

(6) Evaluation of Adhesiveness

In accordance with JIS K5400, the surface layer formed on the surface of each polycarbonate board was given a checkerboard cut pattern of 100 square sections in total by making 11 lengthwise cuts and 11 widthwise cuts at intervals of 1 mm in the board with a razor. A piece of commercially available adhesive cellophane tape was applied to the surface layer having a checkerboard cut pattern and then quickly peeled off from the surface layer in the 90° direction. Among the 100 square sections in total, square sections in which the surface layer had not been peeled off from the polycarbonate board and remained were counted.

(7) Evaluation of Weatherability

Each layered body underwent an accelerated weathering test using a super xenon weather meter (“SX-75” manufactured by Suga Test Instruments Co., Ltd.). The haze value and the degree of yellowing (ΔYI) of the layered body after exposure to light for 1000 hours were measured.

All the results of the above evaluations are shown in Table 3.

TABLE 3

| | | Ex. 1 | Ex. 2 | Ex. 3 | Ex. 4 | Ex. 5 | Ex. 6 | Ex. 7 |
|---|---|---|---|---|---|---|---|---|
| First Layer | | M1 | M1 | M1 | M2 | M3 | M4 | M4 |
| Curing | UV dose (mJ/cm2) | 4000 | 4000 | 4000 | 4000 | 4000 | 4000 | 4000 |
| | Firing | | | | | | | 125° C. * |
| | | | | | | | | 2 h |
| Second Layer | | N1 | N2 | N3 | N4 | N1 | N1 | N1 |
| Curing | Firing | 125° C. * | 125° C. * | 125° C. * | 125° C. * | 125° C. * | 125° C. * | 125° C. * |
| | | 2 h | 2 h | 2 h | 2 h | 2 h | 2 h | 2 h |
| Evaluation Results | First Layer Thickness μ | 8.0 | 8.0 | 8.0 | 8.0 | 8.0 | 8.0 | 8.0 |
| | Second Layer Thickness μ | 5.0 | 5.0 | 5.0 | 5.0 | 5.0 | 5.0 | 5.0 |
| | External Appearance | ◯ | ◯ | ◯ | ◯ | ◯ | ◯ | ◯ |
| | Transparency (haze) | 0.5 | 0.5 | 0.5 | 0.5 | 0.5 | 0.5 | 0.5 |
| | Yellowing | 1.7 | 1.7 | 1.7 | 4.8 | 1.7 | 1.7 | 1.7 |
| | Abrasion Res. (Δhaze) | 3.4 | 4.5 | 3.9 | 3.4 | 5.2 | 3.8 | 22.6 |
| | Adhesiveness | 100 | 100 | 100 | 100 | 100 | 100 | 100 |
| | Weatherability: Haze | 0.5 | 0.5 | 0.5 | 0.5 | 0.5 | 0.5 | 0.5 |
| | Weatherability: Yellowing | 1.8 | 1.8 | 1.8 | 5.0 | 2.0 | 1.8 | 1.8 |

| | | | | Comp. | Comp. | Comp. | Comp. |
|---|---|---|---|---|---|---|---|
| | | Ex. 8 | Ex. 9 | Ex. 1 | Ex. 2 | Ex. 3 | Ex. 4 |
| First Layer | | M5 | M1 | M1 | M1 | M1 | M5 |
| Curing | UV dose (mJ/cm2) | 4000 | 4000 | 4000 | 4000 | 4000 | 4000 |
| | Firing | | | | | | |
| Second Layer | | N1 | N5 | N6 | N7 | N8 | N1 |
| Curing | Firing | 125° C. * | 125° C. * | 125° C. * | 125° C. * | 125° C. * | 125° C. * |
| | | 2 h | 2 h | 2 h | 2 h | 2 h | 2 h |
| Evaluation Results | First Layer Thickness μ | 8.0 | 8.0 | 8.0 | 8.0 | 8.0 | 8.0 |
| | Second Layer Thickness μ | 5.0 | 5.0 | 5.0 | 5.0 | 3.0 | 5.0 |
| | External Appearance | ◯ | Δ | ◯ | ◯ | ◯ | ◯ |
| | | | Varied | | | | |
| | | | Thickness | | | | |
| | Transparency (haze) | 0.3 | 1.2 | 0.3 | 0.5 | 2.4 | 0.3 |
| | Yellowing | 0.8 | 1.7 | 1.7 | 1.7 | 1.7 | 0.9 |
| | Abrasion Res. (Δhaze) | 3.2 | 21.5 | 44.7 | 41.5 | 57.7 | 30.6 |
| | Adhesiveness | 100 | 100 | 100 | 100 | 100 | 100 |
| | Weatherability: Haze | 0.5 | 1.3 | 0.4 | 0.5 | 3.6 | 1.3 |
| | Weatherability: Yellowing | 20.3 | 1.8 | 1.6 | 1.8 | 1.8 | 1.2 |

### REFERENCE SIGNS LIST

1 layered body
2 resin substrate
2a surface
3 first layer
3a one side
3b the other side
4 second layer
11 first composition layer
11A photocured first composition layer
11a one side
11b the other side
12 second composition layer

1. A layered body comprising:
a resin substrate;
a first layer deposited at one side on at least one surface of the resin substrate; and
a second layer deposited on the other side of the first layer opposite to the one side thereof at which the first layer is deposited on the resin substrate,
wherein the first layer is a first organic-inorganic hybrid layer containing a (meth)acrylic resin and a silane compound, and
the second layer is a second organic-inorganic hybrid layer obtained by curing a composition made of a solution obtained by hydrolysis and condensation using a silane compound (A) containing at least one epoxy group and represented by the following Formula (1), an aluminum alkoxide (B) represented by the following Formula (2), and a tetrafunctional silane compound (C) represented by the following Formula (3):
Si(R1)ₚ(OR2)₄₋ₚ Formula (1)
where R1 represents a C₁₋₃₀ organic group containing an epoxy group, R2 represents a C₁₋₆ alkyl group, p is 1 or 2, the R1s are of the same or different types when p is 2, and the R2s are of the same or different types;
Al(OR3)₃ Formula (2)
where R3 represents a C₁₋₆ alkyl group and the R3s are of the same or different types; and
Si(OR4)₄ Formula (3)
where R4 represents a C₁₋₆ alkyl group and the R4s are of the same or different types.

2. The layered body according to claim 1, wherein the first layer is made of a cured product obtained by curing an active energy ray-curable composition containing: an inorganic polymer component obtained by hydrolyzing and condensing at least a silane compound represented by the following Formula (4); a water-soluble polyfunctional (meth)acrylate; and an active energy ray polymerization initiator:
Si(R5)ₚ(OR6)₄₋ₚ Formula (4)
where R5 represents a C₁₋₃₀ organic group containing a polymerizable double bond, R6 represents a C₁₋₆ alkyl group, p is 1 or 2, the R5s are of the same or different types when p is 2, and the R6s are of the same or different types.

3. The layered body according to claim 2, wherein the water-soluble polyfunctional (meth)acrylate is an oxyalkylene-modified glycerol (meth)acrylate represented by the following Formula (5) or an alkylene glycol di(meth)acrylate represented by the following Formula (6): 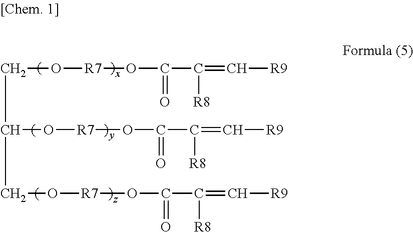
where R7 represents an ethylene group or a propylene group, R8 represents a hydrogen atom or a methyl group, R9 represents a hydrogen atom or a methyl group, the sum of x, y and z is an integer of 6 to 30, and the members of each of the set of R7s, the set of R8s and the set of R9s are of the same or different types; or 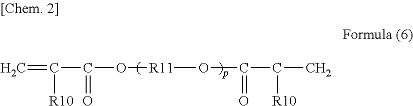
where R10 represents a hydrogen atom or a methyl group, R11 represents an ethylene group or a propylene group, and p is an integer of 1 to 25.

4. The layered body according to claim 3, obtained by coating the composition for forming the first layer on the resin substrate, then curing the composition by radical-co-polymerizing the water-soluble polyfunctional (meth)acrylate and polymerizable double bond moieties of the silane compound represented by the above Formula (5) by exposure to active energy rays, then coating the composition for forming the second layer on the cured composition and then curing the composition for forming the second layer by hydrolyzing and condensation-polymerizing alkoxy groups of metal alkoxides contained in the first and second layers by heat application.

5. The layered body according to claim 1, wherein the second layer is an organic-inorganic hybrid layer obtained by curing a solution containing not only the solution obtained by hydrolysis and condensation using the silane compound but also a silicone surfactant.

6. The layered body according to any one of claims 1 to 5, wherein the first layer further contains at least one of an ultraviolet ray absorber and a hindered amine light stabilizer.

7. The layered body according to claim 6, wherein the ultraviolet ray absorber is a hydroxyphenyltriazine ultraviolet ray absorber.

8. A method for manufacturing a layered body, the method comprising:
the step of coating a first composition containing a (meth)acrylic resin and a silane compound on at least one surface of a resin substrate;
a curing step of curing the first composition by exposure to active energy rays to form a first layer;
the step of coating on the first layer a second composition which contains a silane compound containing at least one epoxy group and represented by the following Formula (1), an aluminum alkoxide represented by the following Formula (2), and a tetrafunctional silane compound represented by the following Formula (3); and
the step of curing the second composition by hydrolyzing and condensation-polymerizing alkoxy groups contained in the second composition by heat application to form a second layer:
Si(R1)ₚ(OR2)₄₋ₚ Formula (1)
where R1 represents a C₁₋₃₀ organic group containing an epoxy group, R2 represents a C₁₋₆ alkyl group, p is 1 or 2, the R1s are of the same or different types when p is 2, and the R2s are of the same or different types;
Al(OR3)₃ Formula (2)
where R3 represents a C₁₋₆ alkyl group and the R3s are of the same or different types; and
Si(OR4)₄ Formula (3)
where R4 represents a C₁₋₆ alkyl group and the R4s are of the same or different types.

9. The method according to claim 8, wherein the first layer is an organic-inorganic hybrid layer containing an inorganic polymer component containing an alkoxy group and a silanol group, and the method further comprises the step of further curing the first layer by hydrolyzing and condensation-polymerizing the alkoxy group and the silanol group of the inorganic polymer component contained in the first layer simultaneously with the formation of the second layer.
